(19) United States
(12) Patent Application Publication
(10) Pub. No.: US 2011/0307516 A1
(43) Pub. Date: Dec. 15, 2011

(54) APPARATUS AND METHOD FOR SEARCHING FOR CONTENT IN A PORTABLE TERMINAL

(75) Inventors: Sung-Jae Cho, Seoul (KR); Kwan-Sic Kim, Hwaseong-si (KR)

(73) Assignee: SAMSUNG ELECTRONICS CO., LTD, Suwon-si (KR)

(21) Appl. No.: 13/160,299

(22) Filed: Jun. 14, 2011

(30) Foreign Application Priority Data
Jun. 14, 2010 (KR) 10-2010-0055869

(51) Int. Cl. G06F 17/30

(52) U.S. Cl. 707/774; 707/E17.014; 707/E17.016

(57) ABSTRACT

An apparatus and a method in a portable terminal allow searching for content and provide a function which re-searches and classifies the searched content based on a time line. A 4D data search unit outputs a time setting menu for changing a time line after searching for content corresponding to a keyword, and re-searches for the searched content based on the changed time line that corresponds to a rotation of the time setting menu.

### CROSS-REFERENCE TO RELATED APPLICATION(S) AND CLAIM OF PRIORITY

The present application is related to and claims the benefit under 35 U.S.C. §119(a) to a Korean patent application filed in the Korean Intellectual Property Office on Jun. 14, 2010, and assigned Serial No. 10-2010-0055869, the entire disclosure of which is hereby incorporated by reference.

### TECHNICAL FIELD OF THE INVENTION

The present invention relates generally to an apparatus and a method for searching for content in a portable terminal. More particularly, the present invention relates to an apparatus and a method for searching for content and providing a function that re-searches and classifies the searched content based on a time line in a portable terminal.

### BACKGROUND OF THE INVENTION

The use of portable terminals has grown rapidly such that the portable terminal has effectively become a necessity in modern life. Portable terminals are used as a medium for wireless voice communication and information exchange.

When first introduced, the portable terminal provided features of portability and wireless communication. As technology advanced, service providers and portable terminal manufacturers began to competitively develop products and services to distinguish themselves from others.

For example, advanced portable terminals are now provided as multimedia devices and support such functions as a phonebook, a game, Short Message Service (SMS), an Electronic (E)-mail service, a morning call, a Motion Picture Expert Group (MPEG)-3 (MP3) player, a schedule management function, a digital camera, and a wireless Internet service.

Lately, as an additional service using a map rises as a promising business model of the Internet, portable terminals are providing the additional service using the map.

The additional service using the map, rather than merely providing the map on the plane, has advanced to a satellite photograph function and a 3D stereoscopic screen, and its map information is frequently updated by a service provider.

In addition, the additional service using the map allows content search using a service provided over the Internet and can interwork with other services such as news service and real estate service.

However, as content types increase and a search engine for the content search progresses, the additional service using the map cannot search for user's intended information at a time.

For example, when a user of the portable terminal searches for a case A, the portable terminal search for every case A taking place in a defined area.

Because the case A is searched regardless of the year or the place as stated above, the portable terminal has to check every individual search result and find the necessary content.

### SUMMARY OF THE INVENTION

To address the above-discussed deficiencies of the prior art, it is a primary aspect of the present invention to provide an apparatus and a method for enhancing a content search performance in a portable terminal.

Another aspect of the present invention is to provide an apparatus and a method for intuitively classifying a great amount of contents in a portable terminal.

Another aspect of the present invention is to provide an apparatus and a method for classifying content search results according to a time change in a portable terminal.

Yet another aspect of the present invention is to provide an apparatus and a method for searching for content using 4D information in a portable terminal.

In accordance with an aspect of the present invention, an apparatus for searching for a content in a portable terminal is provided. The apparatus includes a 4D data search unit for outputting a time setting menu for changing a time line after searching for a content corresponding to a keyword, and re-searching for the searched content based on the changed time line that corresponds to a rotation of the time setting menu.

In accordance with another aspect of the present invention, a method for searching for a content in a portable terminal is provided. A time setting menu for changing a time line is output after content corresponding to a keyword is searched. the searched content is re-searched based on the changed time line that corresponds to a rotation of the time setting menu.

In accordance with another aspect of the present invention, an apparatus for searching for a content in a portable terminal is provided. The apparatus includes a display unit, a controller, a 4D data search unit, and an input unit. The controller outputs a time setting menu for reclassifying searched contents to the display unit after searching for the content corresponding to a keyword. The 4D data search unit for re-searches for the searched content with a changed search range when a search range is changed through the output time setting menu. The input unit receives input for changing the search range using the output setting menu. The 4D data search unit reclassifies the contents by obtaining content information corresponding to the changed search range among pre-stored content information, and outputs the reclassified contents to the display unit.

Before undertaking the DETAILED DESCRIPTION OF THE INVENTION below, it may be advantageous to set forth definitions of certain words and phrases used throughout this patent document; the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a portable terminal for classifying content search results based on a time line according to an embodiment of the present invention;

FIG. 2 illustrates a process for registering a content to the portable terminal according to an embodiment of the present invention;

FIG. 3 illustrates a process for searching for a content in the portable terminal according to an embodiment of the present invention;

FIG. 4 illustrates a process for reclassifying the searched contents using a time setting menu in the portable terminal according to an embodiment of the present invention;

FIG. 5A illustrates a screen showing the searched contents in the portable terminal according to an embodiment of the present invention;

FIG. 5B illustrates a screen increasing the time line based on the time set in the content search through the time setting menu in the portable terminal according to an embodiment of the present invention;

FIG. 5C illustrates a screen decreasing the time line based on the time set in the content search through the time setting menu in the portable terminal according to an embodiment of the present invention;

FIG. 5D illustrates a screen increasing the time line to a longer span in the portable terminal according to an embodiment of the present invention; and

FIG. 5E illustrates a screen decreasing the time line to a shorter span in the portable terminal according to an embodiment of the present invention.

Throughout the drawings, like reference numerals will be understood to refer to like parts, components and structures.

### DETAILED DESCRIPTION OF THE INVENTION

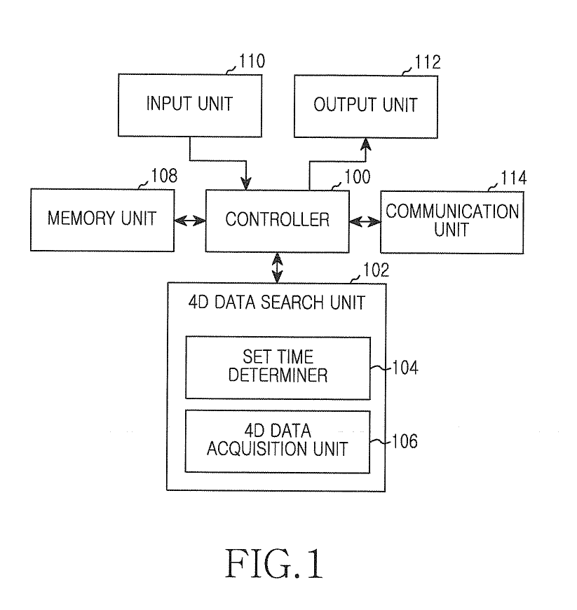

FIGS. 1 through 5E, discussed below, and the various embodiments used to describe the principles of the present disclosure in this patent document are by way of illustration only and should not be construed in any way to limit the scope of the disclosure.

Embodiments of the present invention provide an apparatus and a method for reclassifying content search results based on a search time line to enhance a content search performance in a portable terminal. The contents allow regional infouuation to be searched by a user, news, events/accidents, and real estate information in a particular region.

FIG. 1 illustrates a portable terminal for classifying content search results based on a time line according to an embodiment of the present invention.

As shown in FIG. 1, the portable terminal may include a controller 100, a 4D data search unit 102, a memory unit 108, an input unit 110, a display unit 112, and a communication unit 114. The 4D data search unit 102 may include a set time determiner 104 and a 4D data acquisition unit 106.

The controller 100 controls operations of the portable terminal. For example, the controller 100 processes and controls voice communication and data communication. In addition to the normal functions, when registering content, the controller 100 processes to register the content together with 4D information corresponding to the contents.

Herein, the 4D information, which is location (map) information corresponding to the content to search, includes latitude, longitude, and altitude information of the content and time (period) information (e.g., content generation (occurrence) time) related to the content.

When a content search request takes place, the controller 100 obtains a keyword for the request and processes to search for the content corresponding to the keyword among pre-stored contents.

After searching for the content, and upon confirming change of a search time line from a user, the controller 100 processes to classify and output the content corresponding to the search time changed by the user.

The 4D data search unit 102 processes to register the content together with the 4D information under control of the controller 100. In detail, the 4D data search unit 102 obtains and registers location information and time information of the content to register, together with the content. When the user searches for the content, not only the location information of the content for the keyword but also the contents of the keyword are provided on the time line basis.

The content can be searched and registered by the portable terminal itself or in connection with a server which manages the contents. Accordingly, when the contents are managed by connecting to the server, the 4D data search unit 102 processes to register the content and the 4D information corresponding to the content to the server.

The set time determiner 104 of the 4D data search unit 102 determines the time line of the content to be searched by the user of the portable terminal and provides the determined time line to the 4D data search unit 102. That is, the set time determiner 104 can confirm the change of the time line of the content to search by detecting a rotation of a time setting menu.

The 4D data acquisition unit 106 of the 4D data search unit 102, which obtains the 4D data to register together with the content, acquires and provides the location information (the latitude, the longitude, and the altitude) information and the time information of the content to register to the 4D data search unit 102. For example, when the portable terminal obtains an image using a camera function, the 4D data acquisition unit 106 obtains location information and time information of the obtained image.

The memory unit 108 preferably includes, for example, a Read Only Memory (ROM), a Random Access Memory (RAM), a flash ROM, and such. The ROM contains microcodes and reference data of a program for processing and controlling the controller 100 and the 4D data search unit 102.

The RAM, which is a working memory of the controller 100, stores temporary data generated during the program execution. The flash ROM stores updatable storage data such as a phone book, outgoing messages, incoming messages, and such. According to an embodiment of the present invention, the memory unit 108 stores the content and the 4D information corresponding to the content.

The input unit 110 includes a plurality of function keys such as number key buttons 0˜9, a menu button, a cancel button, an OK button, a call button, an end button, an Internet access button, navigation key buttons, a character input key, and such. The input unit 110 provides the controller 100 with key input data corresponding to the key pressed by the user. According to an embodiment of the present invention, the input unit 110 generates information for the content search and information to classify the searched contents.

The display unit 112 displays state information, characters, videos, and still images generated during the operation of the portable terminal. The display unit 112 can employ a color Liquid Crystal Display (LCD), Active Mode Organic Light Emitting Diode (AMOLED), and such. When the display unit 112 includes a touch input device and is applied to a touch-type portable terminal, the display unit 112 can be used as the input device. According to an embodiment of the present invention, the display unit 112 outputs the searched contents and information related to the classified contents based on the preset time line or the changed time line.

The communication unit 114 processes to send and receive radio signals of the data input and output via an antenna (not illustrated). For example, for the transmission, the communication unit 114 channel-codes and spreads data to transmit, processes the data to a Radio Frequency (RF) signal, and transmits the RF signal. For the reception, the communication unit 114 converts a received RF signal to a baseband signal and restores the data by de-spreading and channel-decoding the baseband.

While the controller 100 of the portable terminal can function as the 4D data search unit 102, they are separately illustrated here to distinguish various functions of the present invention, not to limit the scope of the invention. One skilled in the art should understand that various modifications can be made without departing from the spirit and scope of the invention. For example, the controller 100 can process all of the functions of the 4D data search unit 102.

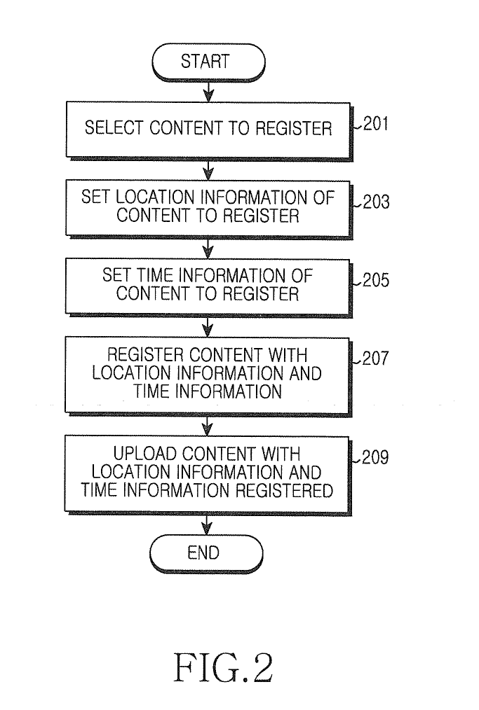

FIG. 2 illustrates a process for registering the content to the portable terminal according to an embodiment of the present invention.

The portable terminal can register the content to the memory of the portable terminal or to a specific server which manages the contents.

For doing so, the portable terminal selects the content to register in step 201 and sets the location information of the content to register in step 203. Herein, the location information, which is location information where the content to register is generated, indicates the latitude, longitude, and altitude information of the region of the content. For example, when the content is a news article, the location information indicates location information of the region where the corresponding news takes place. When the content is image data, the location information can be location information of the obtained image data.

In step 205, the portable terminal sets the time information of the content to register. Herein, the time information is information such as content generation time such that the content results of the user's keyword can be classified based on the time line. The location information and the time information are defined as the 4D information.

In step 207, the portable terminal registers and maps the 4D information including the location information and the time information together with the content, which can input the 4D information to tag information of the content.

In step 209, the portable terminal uploads the content with the mapped 4D information. Herein, uploading the content includes storing the content to the memory of the portable terminal or sending the content to the specific server.

Next, the portable terminal finishes this process.

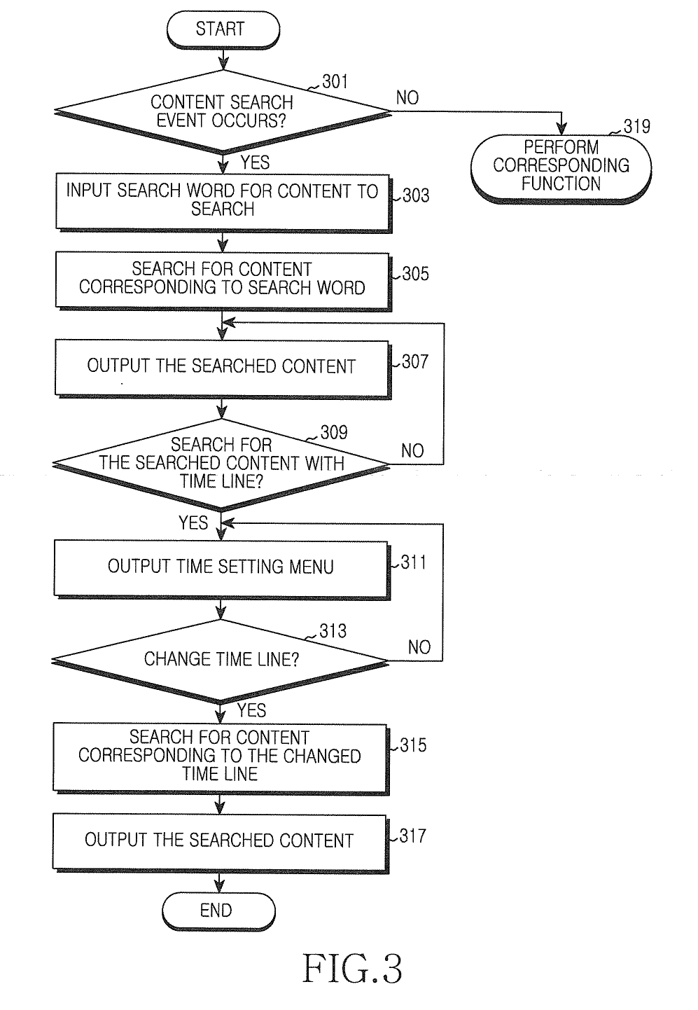

FIG. 3 illustrates a process of searching for the content in the portable terminal according to an embodiment of the present invention.

In step 301, the portable terminal determines whether a content search event takes place. Herein, the content search event indicates an event for searching for news, event/accident, real estate information, and location information wanted by the user by inputting a keyword. The user's intended news, event/accident, location information, and real estate information are defined as contents.

When the content search event does not occur in step 301, the portable terminal performs a corresponding function (e.g., a standby mode) in step 319.

When the content search event occurs in step 301, the portable terminal confirms a search word (keyword) input for the content to search in step 303. That is, in step 303, the keyword for the content to be searched by the user of the portable terminal is input. The portable terminal can receive the keyword and a search range such as search area and search time range.

Next, the portable terminal searches for the content corresponding to the search word input from the user in step 305, and outputs search results (the searched contents) of step 305 in step 307.

In step 309, the portable te minal determines whether there is a request for searching for the searched content based on the time line. Herein, the search based on the time line, which is for classifying the search results output in step 307 based on the time line, changes the search range defined in the content search and then re-searches the searched contents within the changed search range.

When there is no request for searching for the searched content based on the time line in step 309, the portable terminal repeats the step 307.

By contrast, when there is a request for searching for the searched content based on the time line in step 309, the portable terminal processes to output the time setting menu in step 311. Herein, the time setting menu indicates a menu for changing the preset search range in order to reclassify the searched contents based on the time line, and can extend or reduce the preset search range (the time line). Also, the time setting menu can flexibly set a control interval (an increased or decreased span of a preset reference time) of the time setting menu. That is, according to a user's selection, the control interval of the time setting menu can be 10 years 50 years, or any other time range.

In step 313, the portable terminal determines whether the time line, which is the preset search range, is changed through the time setting menu.

When the time line, which is the preset search range, is not changed through the time setting menu in step 313, the portable terminal returns to step 311.

When the time line, which is the preset search range, is changed through the time setting menu in step 313, the portable terminal searches for a content corresponding to the changed time line in step 315. Herein, the step 315 reclassifies only the content corresponding to the changed time line among the contents searched in step 305.

In step 317, the portable terminal outputs the content classified in the step 315 and then finishes this process.

While the portable terminal searches for the user's intended content among its stored contents, the contents can be stored to a specific server and the user's intended content can be provided from the specific server.

To receive the content from the specific server, the portable terminal provides the search word input from the user to the specific server and receives search results corresponding to the search word.

Next, the portable terminal outputs the provided search results and then outputs the time setting menu. The portable terminal provides the time line changed by the user to the specific server such that the server can search for the content corresponding to the changed time line.

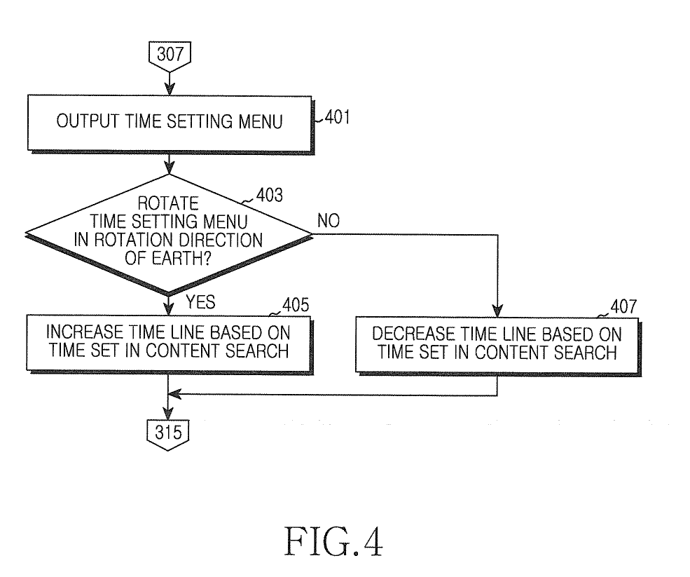

FIG. 4 illustrates a process for reclassifying the searched contents using the time setting menu in the portable terminal according to an embodiment of the present invention.

The portable terminal outputs the time setting menu in step 401 and determines a direction of the time setting menu rotated by the user of the portable terminal in step 403.

As stated above, the time setting menu indicates the menu for changing the preset search range in the content search and can increase or reduce the preset search range. The rotation direction of the time setting menu is examined to determine whether to increase or decrease the set search range. When the time setting menu is rotated in the rotation direction of the earth, the portable terminal increases the search range. When the time setting menu is rotated in the opposite direction of the earth's rotation, the portable terminal accordingly decreases the search range.

Confirming the rotation of the time setting menu in the rotation direction of the earth in step 403, the portable terminal increases the time line based on the time set in the content search in step 405, which expands the set search range.

By contrast, when confirming the rotation of the time setting menu in the opposite direction of the earth's rotation in step 403, the portable terminal decreases the time line based on the time set in the content search in step 407, which reduces the set search range.

The portable terminal, upon changing the set search range, proceeds to step 315 of FIG. 3.

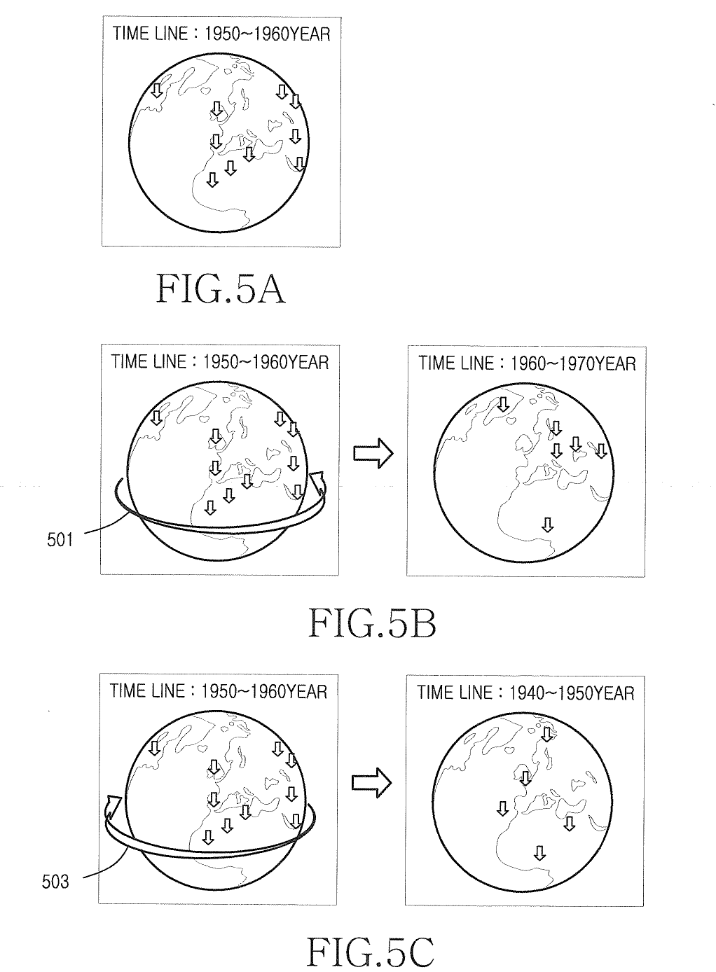

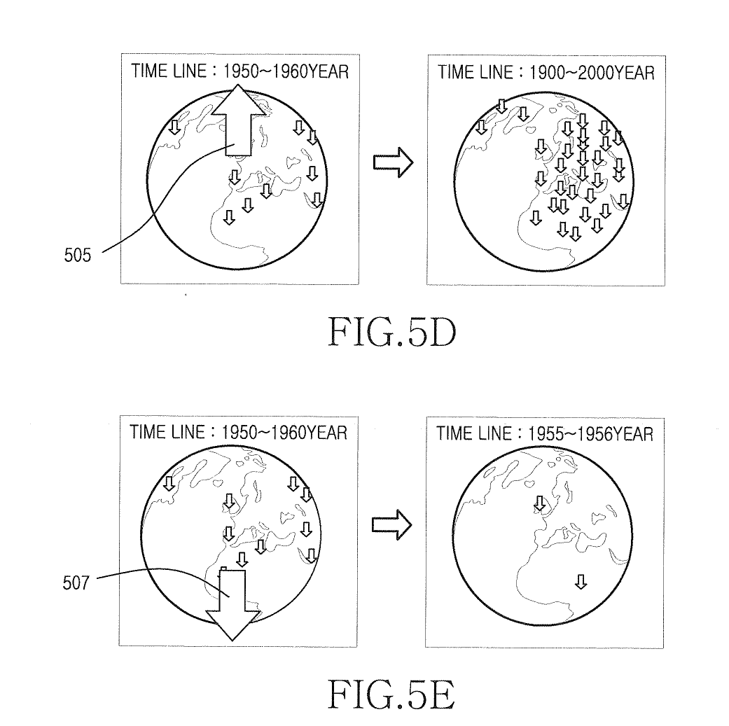

FIGS. 5A and 5E illustrate content search screens of the portable terminal according to an embodiment of the present invention.

FIG. 5A illustrates a screen showing the searched contents in the portable terminal according to an embodiment of the present invention.

The user of the portable terminal can enter the keyword for the content to search and obtain the search results as shown in FIG. 5A.

The search results include the plurality of contents as shown in FIG. 5A. As such, the user has a difficulty in searching for his/her intended content precisely.

FIG. 5B depicts the screen which increases the time line based on the time set in the content search through the time setting menu in the portable terminal according to an embodiment of the present invention.

To raise the accuracy of the search results of FIG. 5A, the portable terminal can increase the time line based on the preset time and re-search for the results of the content corresponding to the increased time range as shown in FIG. 5B. When the user of the portable terminal rotates the search screen in the rotation direction 501 of the earth (the time setting menu may not be displayed separately) as shown in FIG. 5B, the portable terminal can determine that the time setting menu is rotated and change the set time for the content search by increasing the preset time (1950˜1960). Such a screen rotation increases the set time for the content search to 1960˜1970, and the search results of FIG. 5A are re-searched with the changed set time.

FIG. 5C depicts the screen which decreases the time line based on the time set in the content search through the time setting menu in the portable terminal according to an embodiment of the present invention.

To raise the accuracy of the search results of FIG. 5A, the portable terminal can decrease the time line based on the preset time and re-search for the results of the content corresponding to the decreased time as shown in FIG. 5C. When the user of the portable terminal rotates the search screen in the opposite direction 503 of the earth's rotation (the time setting menu may not be displayed separately) as shown in FIG. 5C, the portable terminal can determine that the time setting menu is rotated and change the set time for the content search by decreasing the preset time (1950˜1960). Such a screen rotation decreases the set time for the content search to 1940˜1950, and the search results of FIG. 5A are re-searched with the changed set time.

FIG. 5D depicts the screen for increasing the time line to a longer span in the portable terminal according to an embodiment of the present invention.

In FIG. 5D, the portable terminal can flexibly set the change range of the time setting menu which increases or decreases the set search range. When the time line is changed to a fixed range, many rotations of the time setting menu during the long time line change is addressed.

When the user of the portable terminal rotates the search screen in a predefined upward direction 505 (the time setting menu may not be separately displayed) in order to widen the time line as shown in FIG. 5D, the portable terminal can determine that the time setting menu is rotated and change the set time for the content search by expanding the preset time (1950˜1960). For example, this screen rotation may expand the set time for the content search to 1900˜2000, and the search results of FIG. 5A are re-searched with the changed set time.

FIG. 5E depicts the screen which decreases the time line to a shorter span in the portable terminal according to an embodiment of the present invention.

When the user of the portable terminal rotates the search screen in a predefined downward direction 507 (the time setting menu may not be separately displayed) to shorten the time line as shown in FIG. 5E, the portable terminal can determine that the time setting menu is rotated and change the set time for the content search by decreasing the preset time (1950˜1960). For example, this screen rotation may narrow the set time for the content search to 1955˜1956, and the search results of FIG. 5A are re-searched with the changed set time.

So far, while the method reclassifies the searched contents by changing the time line in the portable terminal, the portable terminal of the present invention can reclassify the searched contents by changing the location information. For example, after searching for the stored data, the portable terminal can process to change a storage folder and to reclassify the searched data based on the folder.

As set forth above, to enhance the content search performance in the portable terminal, the user's intended content can be easily searched by means of the menu which classifies the search results based on the search time line.

While the invention has been shown and described with reference to certain embodiments thereof, it will be understood by those skilled in the art that various changes in form and details may be made therein without departing from the spirit and scope of the invention as defined by the appended claims and their equivalents.

What is claimed is:

1. An apparatus for searching for content in a portable terminal, the apparatus comprising:
a 4D data search unit configured to output a time setting menu for changing a time line after searching for the content corresponding to a keyword, and re-search for the searched content based on the changed time line that corresponds to a rotation of the time setting menu.

2. The apparatus of claim 1, wherein the 4D data search unit is further configured to re-search for the searched content by at least one of increasing and decreasing a preset search range.

3. The apparatus of claim 2, wherein the 4D data search unit, when confirming that the time setting menu for changing the search range is rotated in a first direction, is further configured to increase the preset search range, confirm tag infoimation of the searched content, and reclassify contents corresponding to the increased search range.

4. The apparatus of claim 3, wherein the 4D data search unit, when confirming that the time setting menu for changing the search range is rotated in a second direction, is further configured to decrease the preset search range, confirm the tag information of the searched content, and reclassify contents corresponding to the decreased search range.

5. The apparatus of claim 1, wherein the time setting menu changes the preset search range to a predefined range or a flexibly set range.

6. The apparatus of claim 1, wherein the content comprises latitude, longitude, altitude, and time range information.

7. The apparatus of claim 1, wherein the content comprises at least one of regional information to be searched by a user, news, an accident/event, and real estate information of a particular region.

8. A method for searching for content in a portable terminal, the method comprising:
outputting a time setting menu for changing a time line after searching for the content corresponding to a keyword; and
re-searching for the searched content based on the changed time line that corresponds to a rotation of the time setting menu.

9. The method of claim 8, wherein the re-searching of the searched content comprises:
increasing a preset search range; and
decreasing the preset search range.

10. The method of claim 9, wherein re-searching of the searched content comprises:
detecting a rotation of the time setting menu which changes the search range;
upon confirming that the time setting menu is rotated in a first direction, increasing the preset search range; and
confirming tag information of the searched content and reclassifying contents corresponding to the increased search range.

11. The method of claim 10, wherein re-searching of the searched content further comprises:
upon confirming that the time setting menu is rotated in a second direction, decreasing the preset search range; and
confirming the tag information of the searched content and reclassifying contents corresponding to the decreased search range.

12. The method of claim 8, wherein the time setting menu changes the preset search range to one of a predefined range and a flexibly set range.

13. The method of claim 8, wherein the content comprises latitude, longitude, altitude, and time range information.

14. The method of claim 8, wherein the content comprise at least one of regional information to be searched by a user, news, an accident/event, and real estate information of a particular region.

15. An apparatus for searching for content in a portable terminal, the apparatus comprising:
a display unit;
a controller configured to output a time setting menu for reclassifying searched contents to the display unit after searching for the content corresponding to a keyword;
a 4D data search unit configured to re-search for the searched content with a changed search range when a search range is changed through the output time setting menu; and
an input unit configured to receive input for changing the search range using the output setting menu,
wherein the 4D data search unit is further configured to reclassify the contents by obtaining content information corresponding to the changed search range among pre-stored content information, and output the reclassified contents to the display unit.

16. The apparatus of claim 15, wherein the pre-stored content information comprises at least one of location information of, time, and folder information of the content, and
the 4D data search unit comprises a 4D data acquisition unit configured to acquire content information corresponding to the content respectively.

17. The apparatus of claim 15, wherein the 4D data search unit comprises a set time determiner configured to change the search range by at least one of increasing and decreasing a preset search range.

18. The apparatus of claim 17, wherein the set time determiner is further configured to increase the preset search range when the time setting menu is rotated in a first direction, and
the 4D data search unit is further configured to confirm tag information of the searched contents and reclassify contents corresponding to the increased search page.

19. The apparatus of claim 18, wherein the set time determiner is further configured to decrease the preset search range when the time setting menu is rotated in a second direction, and
The 4D data search unit is further configured reclassify contents corresponding to the decreased search page.

20. The apparatus of claim 17, wherein the time setting menu changes the preset search range to one of a predefined range and a flexibly set range
